(19) United States
(12) Patent Application Publication
(10) Pub. No.: US 2009/0184837 A1
(43) Pub. Date: Jul. 23, 2009

(54) METHOD AND DEVICE FOR PROVIDING AUDITORY OR VISUAL EFFECTS

(76) Inventors: Martin De Prycker, Sint-Niklaas (BE); Stephan Paridaen, Sint-Martens-Latem (BE); Koenraad Maenhout, Kortrijk (BE); Bruno Verhenne, Waregem (BE); Rick Buskens, Teuven (BE)

Correspondence Address: BACON & THOMAS, PLLC, 625 SLATERS LANE, FOURTH FLOOR, ALEXANDRIA, VA, 22314-1176, US

(21) Appl. No.: 12/306,199

(22) PCT Filed: Jun. 22, 2007
(86) PCT No.: PCT/BE2007/000065

§ 371 Date: Dec. 22, 2008

(30) Foreign Application Priority Data
Jun. 22, 2006 (EP) 06012790.9

(51) Int. Cl. G08B 21/00

(52) U.S. Cl. 340/686.1

(57) ABSTRACT

The present invention relates to a method and device for providing auditory or visual effects by means of a plurality of audio or light controlling devices (200) grouped within a geographical area. The method comprises determining the position of each of the audio or light controlling devices (200) before communicating data thereto, and after communicating such data, the audio or light controlling devices (200) playing, showing or displaying at least part of such data, the part shown or displayed being based on the determined position of the audio or light controlling devices (200).

### TECHNICAL FIELD OF THE INVENTION

The present invention relates to a method for providing auditory or visual effects by means of a plurality of audio or lighting devices grouped within a geographical area.

### BACKGROUND OF THE INVENTION

Show lights are illumination sources used for stage lighting, e.g. in theatre, show, entertainment.

In earlier stage lighting control, the lanterns that lit up a show were individually cabled for power supply, and were manually operated. Later on, motorised control was provided, whereby lamps were provided with motors for movement, colour changing, foucussing, dimming, beam angle variation and other functions. Still later, computerised consoles came up, using simple scene storage facilities. Computers opened up a new dimension to the whole system: a fader need not be dedicated to a particular dimmer, it can be assigned to any dimmer or set of dimmers. With the faders and buttons on one side and the dimmers on the other side, the computer could be made to control any connection, level or slope that was required between them.

It was quickly realised that a digital communication system between consoles and dimmers was a natural extension of the computers power. But soon a standard interface was desirable. The DMX512 protocol was such standard interface between dimmers and consoles. It started out as a means to control dimmers from consoles and has ended up being used to control intelligent lights, colour changers, yoke spots, strobes, smoke machines, lasers and even confetti dispensers.

The DMX512 protocol comprises a stream of data which is sent over a balanced cable system connected between the data transmitter (usually consoles) and one or more data receivers. A single DMX port, outputting this stream, can pass magnitude value information for a maximum 512 channels (or lesser) only. This port is known as a DMX universe.

The data stream is sent as a packet (DMX packet) of data which is repeated continuously. It consists of starting bits of data which informs the receivers that the packet is being refreshed and then sends out a stream of serial data corresponding to the magnitude value of each channel. Each channel is separated from the other by specified bits of start and stop data.

Addressing and cabling of fixtures attached to a DMX512 console is very cumbersome, Furthermore, position deviations of installed fixtures compared to the original drawings and pre-programmed scenes are time consuming and hard to correct.

### SUMMARY OF THE INVENTION

It is an object of the present invention to provide a system and method for providing auditory or visual effects by means of a plurality of audio or lighting devices grouped within a geographical area.

The above objective is accomplished by a method and device according to the present invention.

In a first aspect, the present invention provides a method for providing auditory or visual effects by means of a plurality of audio or light controlling devices grouped within a geographical area. The method comprises determining the position of the individual audio or light controlling devices within the geographical area, and thereafter communicating acoustic or visual data to each of the audio or light controlling devices. The audio or light controlling devices play at least part of the communicated acoustic data or show at least part of the communicated visual data, the part of the communicated data being played or shown being based on the determined position of the audio or light controlling devices.

The audio devices may be loudspeakers for home, cinema or event use. The light controlling devices may be show lights for theatre or event use.

The acoustic or visual data is provided from a data source such as a sound generator or an image generator, and parts of the acoustic or visual data are distributed among the individual audio or light controlling devices, for example via wireless communication, however not limited thereto.

The acoustic or visual data communicated to each of the audio or light controlling devices may depend on the determined position of each of the audio or light controlling devices.

The light controlling devices may be lighting devices comprising at least one internal light source, i.e. one light source being part of the lighting device. The lighting devices furthermore may control a switch or modulating device for controlling the amount of emitted light. Advantageously, the lighting devices may be LED devices, which is power efficient, as LED devices consume only little power. Therefore, such LED devices can easily be battery-operated. In alternative embodiments, the lighting devices may be moving stage lights, such as gobo projectors for example. The light controlling devices may alternatively or in addition thereto comprise light modulating devices for modulating light of at least one internal light source or at least one external light source.

Determining the position of the individual audio or light controlling devices may be performed by the audio or light controlling devices themselves, e.g. by using GPS positioning information. Alternatively, determining the position of the individual audio or light controlling devices may comprise detecting and localising the audio or light controlling devices. This detecting and localising may comprise communicating between neighboring audio or light controlling devices so as to obtain identification data of neighboring audio or light controlling devices. Alternatively, this detecting and localising may comprise using a camera or scanning light sensor for observing the plurality of audio or light controlling devices. According to still an alternative embodiment, this detecting and localising the audio or light controlling devices may comprise using a transmitter sending a signal upon reception of which the audio or light controlling devices respond by sending their unique identification data. According to yet another alternative embodiment, the detecting and localising may comprise using a global positioning system.

Communicating data to each of the audio or light controlling devices may comprise sending complete sound or illumination information to each audio or light controlling devices, which extract information corresponding to their determined position. This way of working makes data transfer easier, as the data transferred is the same for each audio or light controlling device. Communicating data to each of the audio or light controlling devices may comprise sending complete information to each audio or light controlling device with geographical co-ordinates encoded therein. Geographical co-ordinates encoded in the information allow a device to extract the right information, i.e. the information the audio or light controlling devices needs to play or show or display, from the complete acoustic or visual data information. An advantage of transmitting with the data the geographical co-ordinates to which the data applies is that the audio or light controlling device itself decides whether or not it is in the relevant area, and if so, plays, shows or displays the information.

Alternatively, communicating data to each of the audio or light controlling devices may comprise sending, to each audio or light controlling device, acoustic or visual data information corresponding to its determined position. This way, location dependent data can be sent to the devices. This has the advantage that only limited data transfer to each audio or light controlling device takes place.

A method according to embodiments of the present invention may furthermore comprise synchronising data communicated to each of the audio or light controlling devices. This way, all audio devices play part of the same acoustic track or all light controlling devices show part of the same illumination track, e.g. image, at the same time and less distortions occur.

The audio or light controlling devices may be modules adapted for being mounted to a fixed support, e.g. a stage, a rig, a post, a fagade; they may be mounted in bricks, glass, sills, tiles, transparent concrete (optical fibres in concrete). They may be mounted behind glass. They may be wired or wireless. They may be connected up to a power source, or they may be self supplying in power. They may be connected up to or comprise photovoltaic (PV) cells or wind turbines and generate electricity that is stored locally in battery, capacitor or other power storage means.

In a second aspect, the present invention provides an audio or lighting system for providing auditory or visual effects. The audio or light controlling system comprises a transmission unit, a plurality of individual audio or light controlling devices, and means for determining the position of the individual audio or light controlling devices. Each audio or light controlling devices comprises at least one audio or light source or is adapted to control at least one light source. Each audio or light controlling device furthermore comprises a communication means for receiving data, and a processing means for controlling the least one audio or light source based on received data. The audio or light controlling devices are adapted for receiving data from the transmission unit, and for playing at least part of the communicated acoustic data or showing at least part of the communicated illumination data, the part of the communicated data being played or shown depending on the determined position of the audio or light controlling devices.

The means for determining the position of the individual audio or light controlling devices may be external to the audio or light controlling devices. Alternatively, the means for determining the position of the individual audio or light controlling devices may be internal to the audio or light controlling devices.

The light controlling devices may be lighting devices comprising at least one internal light source, i.e. one light source being part of the lighting device. The lighting devices may be LED modules.

The light controlling devices may alternatively or in addition thereto comprise light modulating devices for modulating light of at least one internal light source or at least one external light source.

The audio or light controlling devices may be movable. They may be portable by a person.

The display system according to embodiments of the present invention furthermore may comprise synchronisation means for synchronising playing or displaying of the data received by the individual audio or light controlling devices.

In an aspect, the present invention forms audio or light controlling devices by adding intelligence and data communication capabilities to standard audio or light controlling devices, with the ability to emit sound or light, from the conventional sound or light sources. Such audio or light controlling devices communicate with a transmission unit so as to receive data such that the audio or light controlling devices can be controlled to effectively contribute to the provision of auditory or visual effects.

Particular and preferred aspects of the invention are set out in the accompanying independent and dependent claims. Features from the dependent claims may be combined with features of the independent claims and with features of other dependent claims as appropriate and not merely as explicitly set out in the claims.

It will be understood by persons skilled in the art that many other systems, devices and methods can be advantageously designed incorporating the present invention.

The above and other characteristics, features and advantages of the present invention will become apparent from the following detailed description, taken in conjunction with the accompanying drawings, which illustrate, by way of example only, the principles of the invention. This description is given for the sake of example only, without limiting the scope of the invention. The reference figures quoted below refer to the attached drawings.

### BRIEF DESCRIPTION OF THE DRAWINGS

FIG. 1 is a flow diagram of a method according to embodiments of the present invention.

FIG. 2 is a block diagram of a particular embodiment of an audio or lighting device.

FIG. 3 shows a similar example area plan view with example location beacon transmitters.

FIG. 4 illustrates an audio or lighting system according to embodiments of the present invention, comprising a transmission unit and a plurality of audio or lighting devices.

FIG. 5 illustrates an audio or lighting system according to embodiments of the present invention, comprising a transmission unit and a plurality of light controlling device with external light source.

In the different figures, the same reference signs refer to the same or analogous elements.

### DESCRIPTION OF ILLUSTRATIVE EMBODIMENTS

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. The dimensions and the relative dimensions do not correspond to actual reductions to practice of the invention.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

The invention will now be described by a detailed description of several embodiments of the invention. It is clear that other embodiments of the invention can be configured according to the knowledge of persons skilled in the art without departing from the true spirit or technical teaching of the invention, the invention being limited only by the terms of the appended claims.

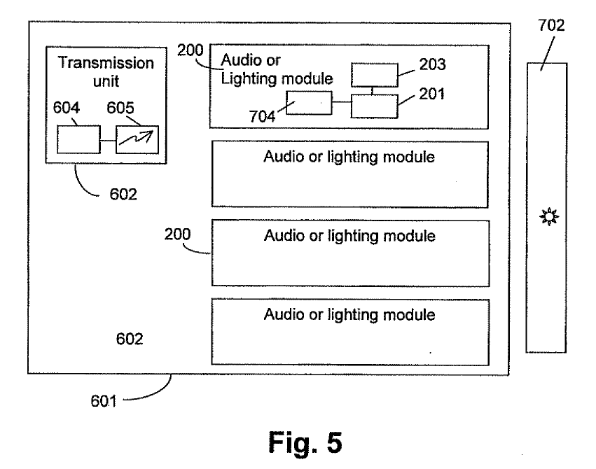

A wireless audio or lighting system 601 for providing auditory or visual effects according to embodiments of the present invention is illustrated in FIG. 4 and FIG. 5 and comprises a transmission unit 602 and a plurality of receiving units 200. The transmission unit 602 comprises a central controller 604 and a first data communication means 605 for communicating acoustic or lighting data to be played or displayed by the receiving units 200.

In some embodiments of the present invention, acoustic data or illumination data is provided by a centralised data source, such as e.g. a digital representation of a piece of music or an illumination pattern, e.g. stored in memory or on a storage device such as an optical disk, solid state memory, tape or magnetic disk. Alternatively, the acoustic data or illumination data may be generated on the fly by a data generator, e.g. operated by an operator. This acoustic data or illumination data is to be distributed among the receiving units 200. Data relating to a sound pattern, e.g. a piece of music, or an illumination pattern e.g. an image, to be played or displayed may, in these embodiments, be the sound pattern or the illumination pattern itself. Each of the receiving units 200, also referred to as audio devices or light controlling devices, e.g. lighting devices, comprises at least one audio or light source 202 or are adapted to control at least one light source 202, 702. The audio devices, or light controlling devices further comprise a data receiver or communicator 203 for at least receiving data communicated by the transmission unit 602, and a module controller 201 for controlling the at least one audio or light source 202 based on received data. Whereas in FIG. 4 light controlling devices are shown which are lighting devices comprising at least one light source 202, e.g. internal light source 202, in embodiments of the present invention reference is also made to light controlling devices based on light translucent and light refelecting technology, such as e.g. devices based on LCD technology or an electrochromatic principle or an electrophoretic principle or an electromechanic principle, etc. The light controlling device 200 then may comprise a light modulating means 704 for controlling a light source, e.g. internal light source or external light source. The example of an external light source 702 is shown in FIG. 5. Thus whereas in the following description reference is made to a lighting device, the latter mutates mutandis refers to a system with a light controlling device whereby the function of the internal light source and the control thereof is replaced by controlling a modulation device for modulation of an external light source.

In alternative embodiments, each receiving unit 200 may be preloaded with one or more audio or illumination patterns, e.g. music or video streams. The receiving units 200 are then provided with memory means for storing the preloaded one or more audio or illumination patterns. In that case, data relating to an image to be played or displayed which is communicated to each of the receiving units 200 may be only identification and/or synchronisation information for enabling each receiving unit 200 to make a selection of the right track of the right piece of music to be played or the right frame of the right video stream to be displayed. Each receiving unit 200 in this embodiment contains the complete acoustic or illumination data, but depending on its position, only a portion thereof is taken out of the stream and is played or displayed by that receiving unit 200.

Such audio or fighting system 601 as illustrated in FIG. 4 may be implemented in a performance event, such as a musical concert, a theatre performance or a promotional activity for example, where auditory and visual effects are desired. Data transmitted from the transmission unit 602 towards each of the receiving units 200 may be used to generate those auditory and visual effects.

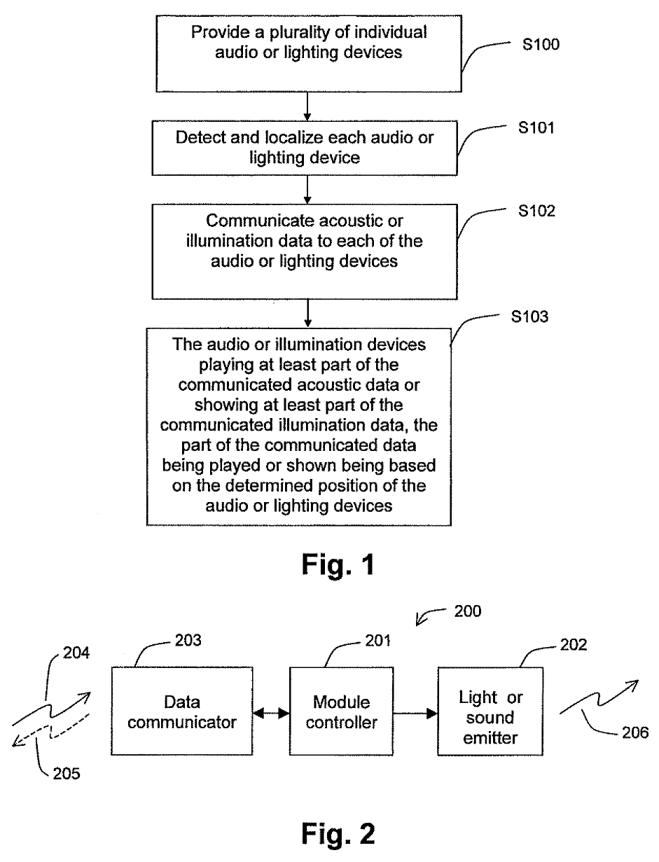

FIG. 1 is a flow diagram of a method according to embodiments of the present invention. The method illustrated in the flow diagram comprises step S100, step S101, step S102 and step S103, and is for communicating data to a plurality of audio or lighting devices 200 grouped within a geographical area. The data communicated relates to a sound pattern to be played or an illumination pattern to be displayed by a combination of the audio or lighting devices 200. The data relating to a sound pattern to be played or an illumination pattern to be displayed may be the sound pattern data or the illumination pattern data itself, or, in case the audio or lighting devices 200 are preloaded with sound pattern or illumination pattern data, only identification and/or synchronisation data. In this latter case, from the identification and/or synchronisation data, each audio or illumination device 200 can work out what sound to play or what illumination to display at what moment in time. The data played or displayed by each of the audio or illumination devices 200 is only part of the complete auditory of visual effect to be provided by the audio or lighting system 601.

At step S100, a plurality of individual audio or lighting devices 200 are provided, e.g. such audio or lighting devices 200 are provided before the start of a performance event at different locations within a geographical area. For example stage lights of showlights may be provided at different places in and/or above and/or around a stage and/or an audience or spectator arena, or loudspeakers may be provided at different places in and/or above and/or around a stage and/or an audience or spectator arena. According to an embodiment, each audio or lighting device 200 has been pre-programmed with a unique address and/or unique identification tag, e.g. identification number, and therefore the transmission unit 602 may communicate with each audio or lighting device 200 individually. Preferred embodiments of the audio or lighting device 200 are described in more detail later in the description with respect to FIG. 2.

Referring again to FIG. 1, according to an embodiment of the present invention, at step S101 the central controller 604 within the transmission unit 602 operates to detect and localise each audio or lighting device 200, i.e. determine the position thereof. The audio or lighting system 601 comprises one or more first data communication units 605 in communication with each other located at one or more positions in and/or above and/or around the audience or spectator arena. At the end of step S101, the central controller 604 of the transmission unit 602 knows the location of each audio or lighting device 200 and each audio or lighting device 200 knows its own location. Examples of this detection and localisation process will be described in more detail below.

At step S102 the transmission unit 602, by means of its first data communication means 605, communicates data to each audio or lighting device 200 where such data is relevant to each audio or lighting device 200 at that time and for the current application. The communicated data may be actual sound data to be played or illumination data to be displayed, or, when acoustic or illumination data has been preloaded into each of the audio or lighting devices 200, only identification and/or synchronisation information.

According to embodiments of the present invention, the communicated data relates to audio or illumination information such that each audio or lighting device 200 outputs a predetermined sound or light of an intensity and possibly colour fitting into the desired audio or illumination pattern to provide the desired auditory or visual effects.

According to another embodiment of the present invention, the netcentric detecting of the location of the audio or lighting devices may be omitted. In this case, co-ordinates are transmitted to the audio or lighting devices, which co-ordinates are determined by the geographical area of interest, e.g. the borders of that geographical area where the auditory or visual effects are to be produced, for example a theatre stage. The audio or lighting devices decide, for example based on GPS positioning information, whether or not they are present in the geographical area of interest. Sound or illumination information containing geographical co-ordinates encoded therein is broadcast to each of the audio or lighting devices. The audio or lighting devices, knowing their position and receiving the sound or illumination information, extract from the received sound or illumination information the portion of interest, i.e. work out from the received complete sound or illumination information which part they are supposed to play or display. Alternatively, when the sound or illumination information is stored locally into each of the audio or lighting devices, each audio or lighting device determines, based on the received co-ordinates and on received identification and/or synchronisation information, whether they need to play or display part of the sound or illumination information or not, as well as which part they need to play or display. Each audio or lighting device in this embodiment contains the complete sound or illumination pattern information, but depending on its position, only a portion thereof is taken out of the stream and is played or displayed by the audio or lighting device.

In some embodiments data is additionally communicated from each audio or lighting device 200 to the transmission unit 602, for example its geographical localisation.

Steps S101 and S102 may be continuously repeated during system operation so that for example as audio or illumination devices move around an arena their new locations are determined so as to receive correct position-related information. In alternative embodiments, in case of a fixed set-up, step S101 is performed only once, after set-up of the sound or illumination system, and step S102 is repeatedly carried out. In this case, audio or illumination devices may be attached at fixed positions, such as for example a stage, a rig, a building, a work of art, seats in a stadium etc. Only when the set-up changes, step S101 needs to be carded out again. In such cases, the position determination is allowed to take a pre-determined amount of time, e.g. a few minutes, as no real-time position information is needed as with moving installations. Multiple corrections may be carried out.

Example means of accomplishing steps S101, S102 and S103 will now be described in more detail.

FIG. 2 is a block diagram of an example audio or lighting device 200 according to an embodiment of the present invention, which audio or lighting device 200 may be attached to a fixed position, e.g. a stage. Audio or lighting device 200 comprises module controller 201, a sound or light emitter 202, and a data communicator 203. The module controller 201 receives data from and may optionally send data to the data communicator 203. The module controller 201 sends control and power signals to the sound or light emitter 202. The sound emitter comprises a speaker, and the light emitter comprises one or more visible-light emitters. The one or more visible-light emitters may be capable of emitting white light, or alternatively may be able to emit multi-coloured light such as red (R), green (G) and blue light (B) 206; persons skilled in the art will know that combinations of R, G and B can be used to produce any colour. The light emitter 202 may preferably comprise one or more LEDs (light emitting diodes), however persons skilled in the art will know that any other known visible-light emitters may be used, such as for example: electroluminescent, backlit-liquid-crystal, incandescent, discharge lamps or plasma. The sound or light emitter 202 may provide information which together with information provided by other sound or light emitters 202 in an audio or lighting system 601 provide a desired auditory or visual effect to observers or spectators. The present invention, when relating to illumination is, however, not limited to mere illumination, but also includes video, images, text, or information. The audio or lighting device 200 may send data (position and/or identification data for example) to the transmission unit 602. The data communicator 203 comprises wireless communication means such as for example a light detector (for visible, infra-red, or ultra-violet for example), radio-frequency antenna, and/or inductive-coupling antenna. The data communicator 203 will receive data 204 from the transmission unit 602 and may receive data from nearby audio or lighting devices 200. The data communicator 203 may send data 205 to the first data communication means 606 of the transmission unit 602 and/or may send data to nearby audio or lighting devices 200. The data communicator may be adapted to receive geographical position data, e.g. by means of a GPS receiver.

The audio or lighting devices 200 may use a same interface for defining their position as the interface they use of transferring/receiving acoustic or illumination data. Examples of communication techniques which may be used in these embodiments are license-free communication bands such as UWB (Ultra Wide Band) or ISM (Industrial, Scientific, Medical) bands, covering communication protocols such as e.g. Bluetooth, WiFi, Zigbee. Alternatively, a licenced frequency band may be used for this type of communication, e.g. GSM, UHF, VHF.

In alternative embodiments, different interfaces may be used for defining position and for transferring acoustic or illumination data. As examples only, the present invention not being limited thereto, for defining position of the audio or lighting devices 200, any of the following communication technologies may be used: license-ree communication bands such as UWB or ISM bands, covering communication protocols such as e.g. Bluetooth, WiFi, Zigbee; using a licenced frequency band, e.g. GSM, UHF, VHF; optical communication, including laserlight, visual, infrared or UV; ultrasound measurement; GPS; radar; detecting local presence of RFIDs in the audio or lighting devices 200 at possible places. Transferring acoustic or illumination data may for example be performed by any of the following, the present invention not being limited thereto, proprietary terrestrial communication bands, e.g. FM, UHF, VHF; DVB (digital), -T (terrestrial), -M (mobile) or -S (satellite); ISM, e.g. WiFi, Zigbee, Bluetooth; sound or illumination patterns may be preloaded and only limited identification and/or synchronisation information may be transmitted, requiring only limited bandwidth; remotely triggered only over any wireless interface. A very precise clock in each audio or lighting device, synchronized only once at startup, can make for some applications wireless synchronisation superfluous.

Independent of the communication techniques used, position determination may for example be performed by any of the following techniques: time based (time*travelling speed=distance), signal/field strength based, phase comparison e.g. carrier phase comparison, angle or direction based e.g. angle of arrival based, inertia sensor (motion sensor), accelerometer, gyroscope, gravity sensors, compass, interference patterns, position distinguishing transmission, proximity detection, any combination or derivative of the above. The above are intended to be examples only, and it is not intended to limit the present invention thereto. They may allow an enhanced position measurement and/or an enhanced orientation measurement.

In accordance with embodiments of the present invention, the detection and localisation resolution (position accuracy) may be high enough to distinguish every singe audio or lighting device 200. Devices spread over a stage and/or an audience or spectator arena may require an accuracy between 10 and 100 cm. Smaller audio or lighting devices 200 that can be arranged closer to each other, may require a much higher position accuracy, as high as in the centimetre range. Positioning accuracy may be down to the centimetre range may for example be advantageous when processing corrections of audio devices, such as e.g. processing phase or delay corrections, is envisaged. The required refresh time of the position measurement may be very low: a once-only initialisation or a refresh rate of not more than, e.g. a few times per minute, e.g. refreshing only every 10 minutes may be sufficient. Dependent on the application, position determination may be 2-dimensional or 3-dimensional. Theoretically there is no limit to the number of audio or lighting devices 200 involved. Practical limits can be the maximum number of devices that can be brought together, but rather the acoustic or illumination data providing seems to be a first limit, although, dependent on the method, high bandwidth for data transmission can be available.

In a particular embodiment, the audio or lighting devices 200 are lighting devices which are video oriented, i.e. adapted for displaying video information. This implies that the lighting devices may have a wide viewing angle (typically 120°) and a wide colour triangle. The plurality of lighting devices may be calibrated so that they all generate a same colour when driven the same way. This calibration may be obtained by gathering the light output information, in particular colour information, and defining the smallest colour triangle common to all lighting devices. This information is then provided to the processing means of each lighting device, for use during processing of data received by the lighting devices.

Example methods to accomplish step S101 (FIG. 1) will now be described.

A first particular method to accomplish step S101 (FIG. 1) uses a handshake principle where each audio or lighting device 200 (FIG. 2) communicates with nearby neighbouring audio or lighting devices 200 such that all audio or lighting devices 200 know the identification data, e.g. identification numbers, of nearby audio or lighting devices 200. Such information is communicated to the transmission unit 602 such that the central controller 604 can operate suitable algorithms to build-up a map of the sequence of audio or lighting device locations and therefore will know the position of each audio or lighting device 200. The position information relating to each audio or lighting device 200 is then communicated to that audio or lighting device 200 via each audio or lighting device's data communicator 203.

A second particular method to accomplish step S101 (FIG. 1) uses a signal detector, e.g. a microphone or a camera, positioned above the stage and/or audience or spectator arena and is therefore able to observe the stage and/or audience or spectator arena. The signal detector, e.g. microphone or camera, communicates with the transmission unit 602 and the transmission unit 602 communicates with all audio or lighting devices 200 to request that they send their unique identification data, e.g. identification numbers, using coded modulation of their sound or light emitters 202. The transmission unit 602 running a suitable algorithm extracts the identification information and position information relating to each identified audio or lighting device 200 from data communicated from the signal detector, e.g. microphone or camera, and therefore will know the position of each audio or lighting device 200. The position information relating to each audio or lighting device 200 is then communicated to that audio or lighting device 200 via each audio or lighting device's data communicator 203.

A third particular method to accomplish step S101 (FIG. 1) uses a signal detector, e.g. a microphone or camera, positioned above the stage and/or audience or spectator arena as described for the second particular method above. The camera communicates with the transmission unit 602 and the transmission unit 602 communicates with all audio or lighting devices 200 individually using their unique identification data, e.g. identification numbers, one at a time to request that they momentary actuate their sound or light emitters 202, i.e. produce a sound or light pattern. The transmission unit 602 running a suitable algorithm extracts the position information from the signal detector relating to each known audio or lighting device 200 and therefore will know the position of each audio or lighting device 200. The position information relating to each audio or lighting device 200 is then communicated to that audio or lighting device 200 via each audio or lighting device's data communicator 203.

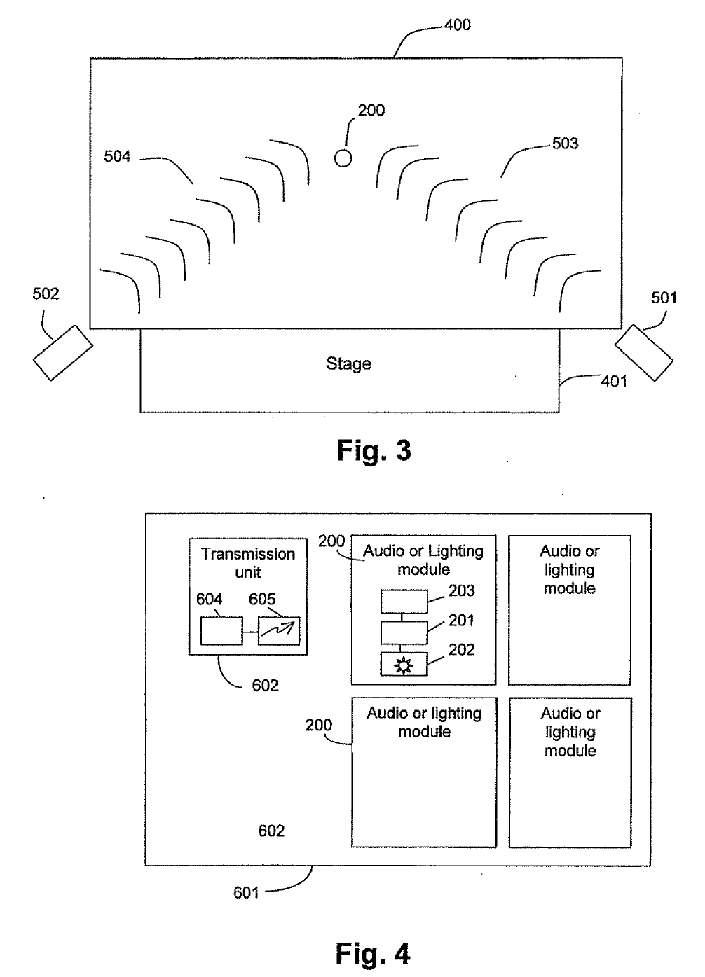

A fourth particular method to accomplish step S101 (FIG. 1) uses two or more transmitters, which are usually located at corners of an arena, FIG. 3 shows an example plan view of an arena 400 and stage 401 showing examples of two such transmitters 501 and 502. Each transmitter 501, 502 sends a signal in only one direction shown as 503 and 504 respectively. The signals may be orthogonal. In FIG. 3 only one audio or lighting device 200 is shown for clarity purposes. The transmitters 501, 502 may scan the arena 400 such that as each audio or lighting device 200 receives such scanning signals 503, 504, it responds by sending its unique identification data, e.g. identification number. The transmitters 501, 502 communicate with the transmission unit 602. The transmission unit 602 running a suitable algorithm extracts the identification information and position information relating to each identified audio or lighting device 200 from data communicated from the transmitters 501, 502 and therefore will know the position of each audio or lighting device 200. The position information relating to each audio or lighting device 200 is then communicated to that audio or lighting device 200 via each audio or lighting device's data communicator 203.

A fifth particular method to accomplish step S101 (FIG. 1) uses a local version of known global positioning systems. Two or more local transmitters send position and time information on a continuous basis and examples of such transmitter locations are shown as 501 and 502 on FIG. 3, however in this case each of their signals are broadcast over the whole of the arena 400. The module controller 201 within each audio or lighting device 200 operates a suitable algorithm (of type known to persons skilled in the art) to determine its own position derived from the signals received via data communicator 203 from transmitters 501 and 502 (FIG. 3).

Persons skilled in the art will know that the methods described above to accomplish step S101 (FIG. 1) are examples only and that other known communication and location methods may be used and/or combinations of the example methods may be used. The accuracy of the detection system determines the quality of the sound played or illumination data shown.

Example methods to accomplish step S102 (FIG. 1) where such communicated data is used to play acoustic data or to display illumination data will now be described. Depending on the available transmission technology and/or the storage capacity of the audio or lighting devices 200 for storing acoustic or illumination data, high resolution or low resolution acoustic or illumination data, or other information related to the acoustic or illumination data, such as identification and/or synchronisation information, can be broadcast. The decision to broadcast high resolution or low resolution acoustic or illumination data can furthermore also be based on any of the available processing power in the audio or lighting devices 200.

A first particular method to accomplish step S102 (FIG. 1) where the communicated data is used to display acoustic or illumination data is such that the transmission unit 602 sends complete acoustic or illumination data information to each audio or lighting device 200. Each audio or lighting device 200 knows its position and so when the acoustic or illumination data relating to that position is received by its data communicator 203 and communicated to its module controller 201, the module controller 201 works out which acoustic data is to be played or which illumination data is to be displayed by the audio or lighting device 200 and causes that information to be played or displayed by the sound or light emitter 202.

A second particular method to accomplish step S102 (FIG. 1) where such communicated data is used to play acoustic data or display illumination data is such that each audio or lighting device 200 communicates with the transmission unit 602 to request acoustic or illumination data relating to the audio or lighting device's known position. Then, when the acoustic or illumination information relating to that position is received by the audio or lighting device's data communicator 203 and communicated to its module controller 201, the module controller 201 causes the acoustic or illumination information to be played or displayed by the sound or light emitter 202.

A third particular method to accomplish step S102 (FIG. 1) where such communicated data is used to display acoustic or illumination data is such that the transmission unit 602 knows the position of each audio or lighting device 200 and sends acoustic or illumination information relating to each audio or lighting device 200 to each audio or lighting device 200 in turn. Each audio or lighting device 200 receives its acoustic or illumination data at the communicator 203 and communicates the data to its module controller 201. The module controller 201 causes the acoustic or illumination information to be played or displayed by the sound or light emitter 202.

A fourth particular method to accomplish step S102 (FIG. 1), where the audio or lighting devices 200 each are preloaded with and store data relating to one or more acoustic or illumination patterns, is, rather than to broadcast the complete acoustic or illumination content to each of the audio or lighting devices 200, to broadcast only identification and/or synchronisation information. Each audio or lighting device 200 knows its position and so when the identification and/or synchronisation information is received by its data communicator 203 and communicated to its module controller 201, the module controller 201 works out which part of the preloaded acoustic or illumination data is to be played or displayed by the audio or lighting device 200 and causes the corresponding acoustic or illumination information to be played or displayed by the sound or light emitter 202.

It is clear that the distribution of data towards the audio or lighting devices 200 and the refresh of such data, in some embodiments of the present invention, should preferably be synchronised in order to allow the audio or lighting devices 200 to receive and process the data received, all audio or lighting devices 200 at the same time. Therefore, the audio or lighting system may be arranged with synchronisation means to form a substantially real-time system to play audio or display illumination patterns.

As a first example of embodiments of the present invention, show lights are considered. Embodiments of the present invention may be used with moving lights and/or LED lights, such as gobo projectors. The lights may be controlled to provide an illumination pattern, which may change in time (colour and/or brightness) and in orientation (in case of movable lights, e.g. gobo projectors). The show lights may be installed according to a protocol, for example DMX512. Position deviations of installed fixtures compared to the original drawings and pre-programmed scenes are time consuming and hard to correct. However, in accordance with embodiments of the present invention, where an accurate position of the show lights is detected and localised, such deviations from pre-programmed illumination patterns are easy to correct for, by correction of the illumination pattern data sent to each of the show lights. The data communicator 203 of the show lights can be a wired or a wireless data communicator. In case of a wireless data communicator 203, in can be built in or attached and connected to the show lights, for example it can be integrated in a DMX plug, which can be plugged in into the DMX devices and thus provide wireless control. 3D positions together with ID and type of fixture can possibly be sent back within RDM DMX, Ethernet or different interface to a central controller. Addressing of each of the show lights can happen automatically. Illumination data can be sent to the show lights, taking into account position deviations compared to the pre-programmed plan.

Also position awareness properties can be added to (a) person(s) or object(s) in a geographical area that are not the audio or lighting devices themselves, but due to awareness of these positions, together with installed lighting or audio devices that have position awareness too, these lighting or audio devices can provide the right light or sound information, colour, direction or properties and automatically adapt to the current position and movements of these person(s) or object(s). I.e. one or more automatically following spots for actors or artists on a stage or speakers playing music only there were visitors are and even the played sound can be fully optimized to the momentary positions were the visitors are in order to maintain a constant volume and prevent interference and phase difference from multiple speakers.

Positions of fixtures, e.g. show lights, attached to a moving rig are real-time known and allow an easier provision of dynamic and coordinated shows.

As a second example of embodiments of the present invention, an audio application is considered. Such audio application may be implemented for home, cinema and event use. Automatic awareness of precise 3D position of audio devices, e.g. loudspeakers, in space and related to each other, in accordance with embodiments of the present invention, enables automatic adjustments for each loudspeaker speaker, such as for example with regard to amplification, phase, delay, equalising.

In particular embodiments, the audio source information can be chosen and even be post mixed from multiple recorded tracks, dependent on the position of each individual audio device, e.g. loudspeaker.

In a simple embodiment of the present invention, an audio device can reproduce the audio track (5.1, 7.1 etc.) that best corresponds to its position in space. Also adjustment in audio properties e.g. amplification, phase, delay, EQ can be performed automatically based on the position of the individual loudspeakers in space and with respect to each other.

A more progressive embodiment of the present invention solves the restriction of the fact that in practice placement of loudspeakers can seldom be optimal to the prescriptions for which a recording is down mixed. The solution according to embodiments of the present invention comprises storing the source information without down mixing and/or post processing to a limited amount of tracks and speaker positions. As an example every recorded sound (e.g. movie or music) that is produced in a different position in space may be recorded separately. The recording for each particular location is stored together with its original position. This recording can still be done within a limited number of tracks and/or storage size, since not too many sounds from different position will be produced simultaneously. Sounds from different positions that do not overlap can be stored on a same track. Finally, when reproduced during use of the audio devices, e.g. loudspeakers, in first instance the actual position of each of the audio devices will be detected and localised. This way, multiple loudspeakers with known positions are available. All tracks of the recorded audio data can be sent to each of the loudspeakers, which determine from the received audio information which tracks are recorded at the position closest to the position where they are placed. Alternatively, a central controller may send to each loudspeakers the tracks which emanate from a recording position closest to where the respective loudspeakers are placed. In either case, the loudspeakers can reproduce the sounds that best correspond to their position. So the “down mixing” happens only when the acoustic data is played. Furthermore, the “down mixing” is fully adapted to the kind and number of used speakers and their individual positions. In some embodiments some post processing can happen, controlled by the module controller inside the loudspeaker or controlled by a central control unit, to adjust for every loudspeaker its acoustical properties, such as e.g. amplification, phase, delay and EQ corresponding to its determined position.

Room information may also be important for performing the adjustment of acoustical properties of the audio devices. Co-ordinates and other characteristics of the room can be obtained and entered in a central transmitter. On top thereof or separately therefrom, listening positions can be determined and entered in a central transmitter. This room and/or listening position information may be sent to the audio devices and may be used when adjusting the acoustical properties of the audio devices. In still alternative embodiments, the co-ordinates and characteristics of the room and/or the listening positions can be automatically detected, e.g. by one or multiple radars, transmitters or cameras.

The audio devices may be active speakers, but the invention is not limited thereto.

It is an advantage of embodiments according to the present invention that the controlled cooperation of light sources or light modulators in the present systems and methods can result in e.g. imaging or displaying data such as images or moving images or video on a large display, i.e. it can result in one large display. It is an advantage of embodiments according to the present invention that the controlled cooperation of light sources or light modulators in the present systems and methods can result in and/or experienced as e.g. on large controlled lighting/colouring surface or light beam.

It is an advantage of embodiments according to the present invention that the controlled cooperation of audio devices in the presented methods and systems, such as e.g. audio speakers can result in a sound surrounding experience. It is an advantage of embodiments according to the present invention that the controlled cooperation of audio devices in the presented methods and systems can result in a phased array of audio devices adapted for or allowing to change the radiation pattern and/or direction of collectively produced acoustic waves.

One other example of an application of embodiments of the present invention, the invention not being limited thereto, is correction of Doppler distortion for moving speakers or listeners. The latter can be obtained due to awareness of the position, e.g. relative position, and/or the speed of the speakers or listeners. Taking into account this data allows to determine the correction required for reducing or removing Doppler distortion.

It is to be understood that although preferred embodiments, specific constructions and configurations, have been discussed herein for devices according to the present invention, various changes or modifications in form and detail may be made without departing from the scope and spirit of this invention. For example, embodiments of the present invention have been described by referring to audio or illumination devices 200. In particular embodiments, such devices could include both a sound and a light emitter, in order to be able to provide both acoustic and visual effects, separately or simultaneously.

Furthermore, position determination may happen wirelessly. Audio or illumination data transfer may advantageously be performed wireless, as this reduces the cabling to be performed; however, the present invention is not limited thereto and embodiments of the present invention also include wired set-ups.

Applications of embodiments of the present invention may be to create a trend, a fashion, a hype; it may be used for promotion of goods, or advertisement; it may have applications in theatre, show and entertainment; and it may be applied to artistic presentations.

1-19. (canceled)

20. Method for providing auditory or visual effects by a plurality of audio or light controlling devices (200) grouped within a geographical area, the method comprising:
communicating (S102) acoustic or illumination data to each of the audio or light controlling devices (200);
the communicated acoustic or illumination data relating to a sound pattern to be played or an illumination pattern to be displayed by a combination of the audio or light controlling devices;
the audio or light controlling devices playing at least part of the communicated acoustic data or showing at least part of the communicated illumination data (S103) determining (S101) the position of each of the audio or light controlling devices (200) within the geographical area before communicating data to each of the audio or light controlling devices (200); and
the part of the communicated data being played or shown being based on the determined position of the audio or light controlling devices (200).

21. Method according to claim 20, wherein the acoustic or illumination data communicated to each of the audio or light controlling devices (200) depends on the determined position of each of the audio or light controlling devices (200).

22. Method according to claim 20, wherein determining (S101) the position of the audio or light controlling devices (200) is performed by the audio or light controlling devices (200) themselves.

23. Method according to claim 20, wherein determining (S101) the position of the audio or light controlling devices (200) comprises detecting and localising the audio or light controlling devices (200).

24. Method according to claim 23, wherein determining (S101) the position of the audio or light controlling devices (200) comprises communicating between neighboring audio or light controlling devices (200) so as to obtain identification data of neighboring audio or light controlling devices (200).

25. Method according to claim 23, wherein determining (S101) the position of the audio or light controlling devices (200) comprises using a camera for observing the set-up of the audio or light controlling devices (200).

26. Method according to claim 23, wherein determining (S101) the position of the audio or light controlling devices (200) comprises using a transmitter sending a signal upon reception of which the audio or light controlling devices (200) respond by sending their unique identification data.

27. Method according to claim 23, wherein determining (S101) the position of the audio or light controlling devices (200) comprises using a global positioning system.

28. Method according to claim 20, wherein communicating (S102) acoustic or illumination data to each of the audio or light controlling devices (200) comprises sending complete acoustic or illumination information to each audio or light controlling device (200), which extracts relevant information corresponding to its determined position.

29. Method according to claim 28, wherein communicating (S102) acoustic or illumination data to each of the audio or light controlling devices (200) comprises sending complete information to each audio or light controlling device (200) with geographical co-ordinates encoded therein.

30. Method according to claim 20, wherein communicating (S102) data to each of the audio or light controlling devices (200) comprises sending to each audio or light controlling device (200) sound or illumination information corresponding to its determined position.

31. Method according to claim 20, furthermore comprising synchronizing data communicated to each of the audio or light controlling devices (200).

32. Audio or lighting system (601) for providing auditory or visual effects, the audio or lighting system (601) comprising:
a transmission unit (602);
a plurality of audio or light controlling devices (200) each comprising at least one audio or light source (202) or adapted to control at least one light source (202), the plurality of audio or light controlling devices (200) further comprising a communication unit (203) adapted to receive data, and a processing unit (201) adapted to control the at least one audio or light source (202) based on received data, the received data relating to a sound pattern to be played or an illumination pattern to be displayed by a combination of the audio or light controlling devices,
the audio or light controlling devices (200) being adapted for receiving data from the transmission unit (602), and for playing at least part of the communicated acoustic data or showing at least part of the communicated illumination data;
a unit arranged to determine the position of the individual audio or light controlling devices (200); and
the part of the communicated data being played or shown being dependent on the determined position of the audio or light controlling devices (200).

33. An audio or lighting system according to claim 32, the audio or light controlling devices comprising lighting devices (200) having at least one internal light source (202).

34. An audio or lighting system according to claim 32, the audio or light controlling devices comprising light modulating devices (704) arranged to modulate light of at least one internal (202) or external light source (702).

35. Display system (601) having an audio or lighting system according to claim 32, wherein the unit arranged to determine the position of the individual audio or light controlling devices (200) is external to the audio or light controlling devices (200).

36. Display system (601) having an audio or lighting system according to claim 32, wherein the unit arranged to determine the position of the individual audio or light controlling devices is internal to the audio or light controlling devices (200).

37. Display system having an audio or lighting system according to claim 32, wherein the audio or light controlling devices are movable.

38. Display system having an audio or lighting system according to claim 32, furthermore comprising a synchronizer arranged to synchronize playing or showing of the data received by the audio or light controlling devices (200).
